(19) United States
(12) Patent Application Publication
(10) Pub. No.: US 2005/0097838 A1
(43) Pub. Date: May 12, 2005

(54) Covers for door jambs and mullions

(75) Inventor: Lawrence Frank Kerscher, De Pere, WI (US)

Correspondence Address: WILHELM LAW SERVICE, S.C., 100 W LAWRENCE ST, THIRD FLOOR, APPLETON, WI, 54911, US

(73) Assignee: Bay Industries, Inc., Green Bay, WI (US)

(21) Appl. No.: 11/005,725

(22) Filed: Dec. 7, 2004

Related U.S. Application Data
(63) Continuation of application No. 10/109,759, filed on Mar. 28, 2002.
(60) Provisional application No. 60/355,592, filed on Feb. 7, 2002.

(51) Int. Cl. E06B 1/04

(52) U.S. Cl. 52/204.1

(57) ABSTRACT

Metal cladding as jamb cover assemblies and mullion cover assemblies, for door frames and mullions, using extrusions as cladding over substrates. A jamb cover assembly includes a jamb plate, a nosing, and a nailing fin. The nailing fin extends from a distal side of the assembly. Accordingly, the frame can be secured in a rough opening of a building with the nosing assembled to the jamb plate, and using the nailing fin for the securement, without any assembly or disassembly of the frame at the construction site. Regarding the mullion cover assembly, first and second jamb plates are on opposing sides of a mullion substrate. A mullion nosing is assembled to the jamb plates, and bridges the jamb plates to join together the two jamb plates and the nosing, to provide complete overlayment of the outer surface of the mullion substrate and to space the front panel of the nosing from the outer surface of the substrate.

This invention pertains specifically to prefabricated and otherwise cladded metal door frames and mullions, using extrusions as cladding over frame substrate elements.

When installing a door frame into a door opening in a building, it is desirable to have a strong, durable frame which is either prefabricated or easily assembled on the construction site. Preferably, the frame can be assembled at an off-site manufacturing location. In the alternative, it is desirable to have frame elements which are easily assembled at the construction site.

In a typical construction project involving doors, door frames or mullions are fabricated by a frame or mullion fabricator, and shipped to a door assembler. The door assembler receives the frames and/or mullions as fabricated, and assembles e.g. the frames to respective door slabs. The slabs are also commonly purchased separately from slab manufacturers. The door assembler adds the desired glass inset, if any, to the door slab, assembles the door slab to a selected door frame, and ships the thus assembled door, including frame and slab, to the construction site for installation on the building.

Typically, the basic frame is wood. The door assembler can easily up-grade the quality and value of the frame, and thus the quality and value of the door assembly, by installing cladding to the left, right, and top frame substrate members, thus to provide maintenance free, tough, and durable exterior surfaces to the frame.

In one set of known clad structures, a single extrusion is mounted to the substrate, providing covering on both the side surface of the substrate and over the outer surface of the substrate. Such extrusion typically provides interface structure on opposing surfaces of the substrate, whereby each extrusion is limited to the size of substrate with which such extrusion can be used.

In the alternative, a jamb plate cover is provided along a side surface of the substrate, but does not extend over the outer surface of the substrate. A separate nosing grips the jamb plate on a first surface of the substrate and grips the opposing surface of the substrate.

In an improvement in versatility of the cladding, over such structures, it is known to provide a jamb plate which has a main side panel which covers the side surface of the substrate and an outer panel which extends over the outer surface of the substrate. A nosing, such as in a brick mold profile or a window trim profile, is mounted to, and extends over, the outer panel of the jamb plate. The outer edge of the outer panel is coincident with the distal side of the nosing. The outer panel of the jamb plate is used to mount the cladding, and thus the door frame, to framing members of the building, by e.g. screws or other fasteners extending through the outer panel of the jamb plate. Accordingly, the nosing cannot be mounted on the jamb plate while the door frame is being mounted to the building.

Such configuration requires that the nosing be assembled to the jamb plate after the door frame is inserted into the rough opening and mounted to the building. By corollary, the nosing can be shipped to the construction site assembled to the jamb plates, whereupon the nosing must be disassembled from the jamb plates before the door frame can be installed on the building, and then reassembled to the door frame after the door frame has been installed. While such process provides for shipping of the nosing in an assembled configuration, disassembly at the construction site is required.

In an alternative process, the door frame is shipped to the job site without the nosing assembled to the frame. The nosing is shipped separately, though typically in the same shipment. This process saves the disassembly step at the construction site. However, the separate shipment of the nosing bears a risk of the nosing being mishandled, separated from the door frame, and lost, whereupon the installation job can be completed only by shipping an additional nosing to the job site. Another risk inherent in the above process is that a different style nosing will be shipped with the door frame, or that a different style nosing will be shipped as a replacement.

Thus, it is an object of the invention to provide a cladded door frame, including a jamb cover assembly on respective frame substrates, wherein the jamb cover assembly includes a jamb plate, a nosing, and a nailing fin, and wherein the nailing fin is so positioned with respect to the nosing that the door frame can be mounted and secured in a rough opening of a building while the jamb cover assembly is fully assembled to the respective frame substrates.

It is another objective to provide an elongate jamb plate wherein an outer panel, which overlies the outer surface of the respective jamb substrate, and which bears mounting structure for receiving a nosing thereon, is devoid of structure, outwardly of the mounting structure, for mounting the jamb plate to a framing member of a building to which the frame is to be mounted.

It is another object to provide a nosing for mounting on a jamb plate, wherein a nailing fin kerf is disposed on the nosing proximate a distal side of the nosing.

It is another object of the invention to provide, in combination, a jamb plate cooperating with a nosing wherein a mounting fin kerf is disposed in a region from proximate a distal side of the nosing to proximate a mounting structure on the jamb plate mounting the nosing and the jamb plate to each other.

Yet another object is to provide a pre-assembled door frame wherein a jamb cover assembly, comprising a jamb plate and a nosing, is mounted to one or more jamb substrates wherein a mounting fin extends outwardly beyond a distal side of the nosing thereby to enable mounting the jamb cover assembly to a framing member of a building while the nosing is mounted to the jamb plate.

Mullions can be up-graded in much the same manner of adding cladding to mullion substrates.

Accordingly, it is an object of the invention to provide a cladded mullion assembly wherein a mullion nosing is mounted to both first and second jamb plates, the jamb plates being mounted on opposing sides of the mullion substrate, and extending over the outer surface of the mullion substrate, and wherein the nosing is mounted to both of the jamb plates proximate the outer surface of the mullion substrate and thus bridges the jamb plates while covering the entire outer surface of the mullion substrate.

Still another objective is to provide a method of installing a door frame in a door opening in a building, including assembling the door frame assembly at an off-site location, transporting the door frame to the building site, and installing the frame in the building, including securing the mounting fin to building framing members while a respective nosing is installed on a respective jamb plate.

### SUMMARY

The invention generally comprises aluminum cladding as jamb cover assemblies and mullion cover assemblies, for door frames and mullions, using extruded aluminum profiles as cladding over wood frame substrate members. A respective jamb cover assembly includes a jamb plate, a nosing, and a nailing fin. The nailing fin is positioned in the cover assembly such that the nailing fin extends outwardly from a distal side of the jamb cover assembly when the nosing is assembled to the jamb plate. Accordingly, the frame can be secured in a rough opening of a building with the nosing assembled to the jamb plate.

With the nailing fin extending outwardly from the fully assembled jamb cover assembly, namely with the nosing assembled to the jamb plate, the so-clad door frame can be assembled into the rough opening in the building, and secured to the building, using the nailing fin, without any assembly or disassembly of the frame or any of the cover assembly elements at the construction site.

Regarding the mullion cover assembly, first and second jamb plates are positioned on opposing sides of a mullion substrate. A mullion nosing is assembled to mounting structure at the outer panels of the jamb plates, and bridging the jamb plates so as to join together the two jamb plates and the nosing, thus to provide complete overlayment of the outer surface of the mullion substrate and to space the front panel of the nosing from the outer surface of the mullion substrate.

A first expression of the invention is embodied in an elongate jamb plate for mounting on an elongate jamb substrate of a door frame. The jamb plate comprises a main side panel for covering at least a major portion of a side surface of the jamb substrate, along at least a major portion of a length of the jamb substrate; and an outer panel for extending along a least a major portion of the length of the jamb substrate, and configured to extend at an angle transverse to the main side panel, and away from the main side panel and over an outer surface of the jamb substrate, the outer panel bearing mounting structure adapted to mount the outer panel to an elongate nosing. The outer panel is preferably devoid of structure outwardly of the mounting structure for mounting the jamb plate to a framing member of a building to which the door frame is to be mounted.

In some embodiments, the mounting structure comprises first and second spaced legs, extending outwardly from the outer panel, and including locking structure for assisting in locking the nosing to the jamb plate.

In some embodiments, the extension of the outer panel, away from the main side panel, ends proximate an outermost one of the legs.

In preferred embodiments, the jamb plate comprises an aluminum extrusion having nominal profile thicknesses of about 0.06 inch.

A second expression of the invention comprehends an elongate nosing for mounting to an elongate jamb plate, wherein the jamb plate is designed and configured to be mounted on an elongate jamb substrate of a door frame, wherein the jamb plate comprises a main side panel for covering at least a major portion of a side surface of the jamb substrate, along at least a major portion of a length of the jamb substrate, and wherein the jamb plate further comprises an outer panel for extending along a least a major portion of the length of the jamb substrate. The outer panel is configured to extend at an angle transverse to the main side panel, and away from the main side panel and over the outer surface of the jamb substrate, the outer panel bearing a first mounting structure. In such environment, the elongate nosing comprises a second mounting structure, designed and configured to cooperatively mount to the first mounting structure of the jamb plate, thereby to mount the nosing to the jamb plate. The nosing, when mounted to the jamb plate, extends away from the main side panel of the jamb plate to a distal side of the nosing, the nosing comprising a mounting fin kerf proximate the distal side of the nosing and away from the main side panel of the jamb plate.

In preferred embodiments, the nosing comprises first and second spaced legs, connected at spaced locations of the legs to a front panel of the nosing, the second mounting structure being disposed on the legs.

In preferred embodiments, a mounting fin, preferably a polymeric mounting fin, is disposed in the mounting fin kerf.

In highly preferred embodiments, the polymeric mounting fin is deflectable toward the main side panel of the jamb plate, and into proximity with a jamb substrate when the nosing is mounted to a jamb plate which is mounted to a jamb substrate.

Preferably, the nosing comprises an aluminum extrusion having nominal profile thicknesses of about 0.06 inch.

Another expression of the invention comprehends, in combination, an elongate jamb plate, and an elongate nosing for mounting to the elongate jamb plate. The elongate jamb plate comprises a main side panel for covering at least a major portion of a side surface of a jamb substrate, along at least a major portion of a length of the jamb substrate, and an outer panel extending along at least a major portion of the length of the jamb substrate, and extending at an angle transverse to the main side panel, and extending away from the main side panel and over the outer surface of the jamb substrate, the outer panel comprising a first mounting structure. The elongate nosing comprises a second mounting structure, designed and configured to cooperatively engage the first mounting structure of the jamb plate, thereby to mount the nosing and the jamb plate to each other. The nosing, when so mounted to the jamb plate, extends in a direction away from the main side panel of the jamb plate to a distal side of the nosing. The combination of the jamb plate and the nosing, when so mounted to each other, comprises a mounting fin kerf in a region from proximate the distal side of the nosing to proximate the first mounting structure.

The mounting fin kerf can be disposed on either the nosing or the outer panel of the jamb plate.

The combination preferably includes a mounting fin in the mounting fin kerf and extending outwardly beyond the distal side of the nosing and away from the main side panel of the jamb plate.

The first mounting structure preferably comprises first and second studs extending from the outer panel of the jamb plate.

The nosing preferably comprises first and second spaced legs, connected at spaced locations of the legs to a front panel of the nosing, the second mounting structure being disposed on the legs.

Preferably, the mounting structure on the nosing can snap lock to the mounting structure on the outer panel of the jamb plate, preferably to studs on the outer panel of the jamb plate.

A mounting fin is preferably mounted in the mounting fin kerf, the mounting fin preferably comprising a polymeric fin mounted in the combination of the jamb plate and the nosing at the mounting fin kerf.

The mounting fin is preferably deflectable toward the main side panel of the jamb plate, and into proximity with the jamb substrate when the elongate nosing is mounted to the jamb plate and the jamb plate is mounted to a jamb substrate.

Both the jamb plate and the nosing are preferably made from aluminum extrusions having nominal profile thicknesses of about 0.06 inch.

In some embodiments, the invention comprehends a pre-assembled door frame for assembly into a building at an opening in the building. The pre-assembled door frame comprises an elongate jamb substrate having a length, an outer surface for facing outwardly away from the building when the door frame is assembled to the building, and a side surface for facing across the opening where at the door frame is assembled to such building; and a jamb cover assembly on the elongate jamb substrate. The jamb cover assembly comprises an elongate jamb plate comprising a main side panel covering at least a major portion of the side surface of the substrate, along at least a major portion of the length of the substrate, and an outer panel extending along at least a major portion of the length of the substrate, and extending at an angle transverse to the main side panel, and extending away from the main side panel and over the outer surface of the jamb substrate, the outer panel comprising a first mounting structure, and an elongate nosing comprising a second mounting structure, engaged with the first mounting structure on the outer panel of the jamb plate and thereby mounting the nosing and the jamb plate to each other, the nosing extending in a direction away from the main side panel to a distal side of the nosing. The jamb cover assembly comprises a mounting fin extending outwardly beyond the distal side of the nosing and in a direction away from the main side panel of the jamb plate, the mounting fin being sized and configured thereby to enable mounting the jamb cover assembly to a framing member of the building at an outwardly-facing surface of the framing member while the nosing is mounted to the jamb plate.

The invention typically comprehends a mounting fin kerf on one of the nosing and the jamb plate, optionally proximate the distal side of the nosing, the mounting fin being received in the mounting fin kerf.

The nosing optionally comprises first and second spaced legs, connected at spaced locations of the legs to a front panel of the nosing, the mounting structure of the nosing being disposed on said legs.

Preferably the mounting structure on the nosing snap locks to the mounting structure on the outer panel of the jamb plate, preferably to studs on the outer panel of the jamb plate.

In preferred embodiments, the outer panel of the jamb plate is in surface-to-surface relationship with the outer surface of the jamb substrate.

In preferred embodiments, the mounting fin is deflectable so as to be folded against the jamb substrate.

In some embodiments, the invention comprehends a cladded mullion assembly. The mullion assembly comprises a mullion substrate having a length, first and second opposing side surfaces facing in opposing directions, generally along an outer surface of a building when the cladded mullion assembly is installed on such building, and an outer surface facing outwardly from the building when the cladded mullion assembly is installed on the building; a first elongate jamb plate comprising a first main side panel extending along at least a major portion of the first side surface of the mullion substrate, along at least a major portion of the length of the mullion substrate. The first elongate jamb plate further comprises a first outer panel extending along at least a major portion of the length of the mullion substrate, and extending at an angle transverse to the first main side panel, and extending away from the first main side panel and over the outer surface of the mullion substrate, the first outer panel comprising a first mounting structure; a second elongate jamb plate comprising a second main side panel extending along at least a major portion of the second side surface of the mullion substrate, along at least a major portion of the length of the mullion substrate, the second elongate jamb plate further comprising a second outer panel extending along at least a major portion of the length of the mullion substrate, and extending at an angle transverse to the second main side panel, and extending away from the second main side panel and over the outer surface of the mullion substrate toward the first outer panel of the first jamb plate, the second outer panel comprising a second mounting structure; and an elongate nosing comprising a third mounting structure engaged with the first and second mounting structures on the first and second jamb plates and thereby mounting the nosing to the first and second jamb plates such that the nosing bridges the jamb plates, thereby locking together the combination of the nosing and the first and second jamb plates proximate the outer surface of the mullion substrate.

Typically, the nosing comprises a front panel spaced from the outer panels of the first and second jamb plates.

Preferably, the jamb plates and the nosing comprise aluminum extrusions, preferably aluminum extrusions having nominal profile thicknesses of about 0.06 inch.

Preferably, the first and second outer panels of the respective first and second jamb plates are in surface-to-surface relationship with the outer surface of the mullion substrate.

The invention also comprehends a method of installing a door frame in a door opening in a building. The method comprises at an off-site location, assembling the door frame, comprising assembling together left, right, and top frame substrate members, each having a side surface facing inwardly of the opening in the building when installed in the building and an outer surface facing outwardly away from the building when installed in the building, thereby to make a door frame precursor having left, right, and top frame elements; installing, on the substrate members, elongate jamb plates wherein each jamb plate comprises a main side panel covering at least a major portion of the side surface of the respective substrate member, and an outer panel extending along a major portion of the outer surface of the respective substrate member; mounting nosings on the outer panels of the jamb plates; and at at least one of the left, right, and top frame elements, assembling a mounting fin to one of the respective jamb plate and the respective nosing, the mounting fin extending outwardly away from the main side surface and away from both the nosing and the jamb plate.

The method further comprises transporting the so-assembled door frame to the building site; and installing the so-assembled door frame to the building, including securing the mounting fin to a building frame member while the respective nosing is installed on the respective frame plate.

In preferred embodiments, the method includes assembling a mounting fin to each of the left, right, and top frame elements such that the respective mounting fins extend outwardly, away from the main side panels of the jamb plates and generally in directions consistent with the outer panels of the jamb plates when the door frame is assembled to the building.

### BRIEF DESCRIPTION OF THE DRAWINGS

FIG. 1 shows a front elevation view of a door frame of the invention.

FIG. 2 shows an enlarged cross-section of the door frame of FIG. 1, taken at 2-2 of FIG. 1.

FIG. 3 shows a fragmentary cross-section of a jamb cover assembly of the invention having a medium-width nosing, and mounted on a door jamb.

FIG. 4 shows a fragmentary cross-section of a jamb cover assembly of the invention having a brick-mold nosing, and mounted on a door jamb.

FIG. 5 shows a mullion covered on opposing side surface by first and second jamb plates of the invention, and a special mullion nosing cover of the invention mounted to the jamb plates and bridging the jamb plates, thereby to provide a unitary appearance to the face of the mullion while protecting the mullion from the outside environment.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

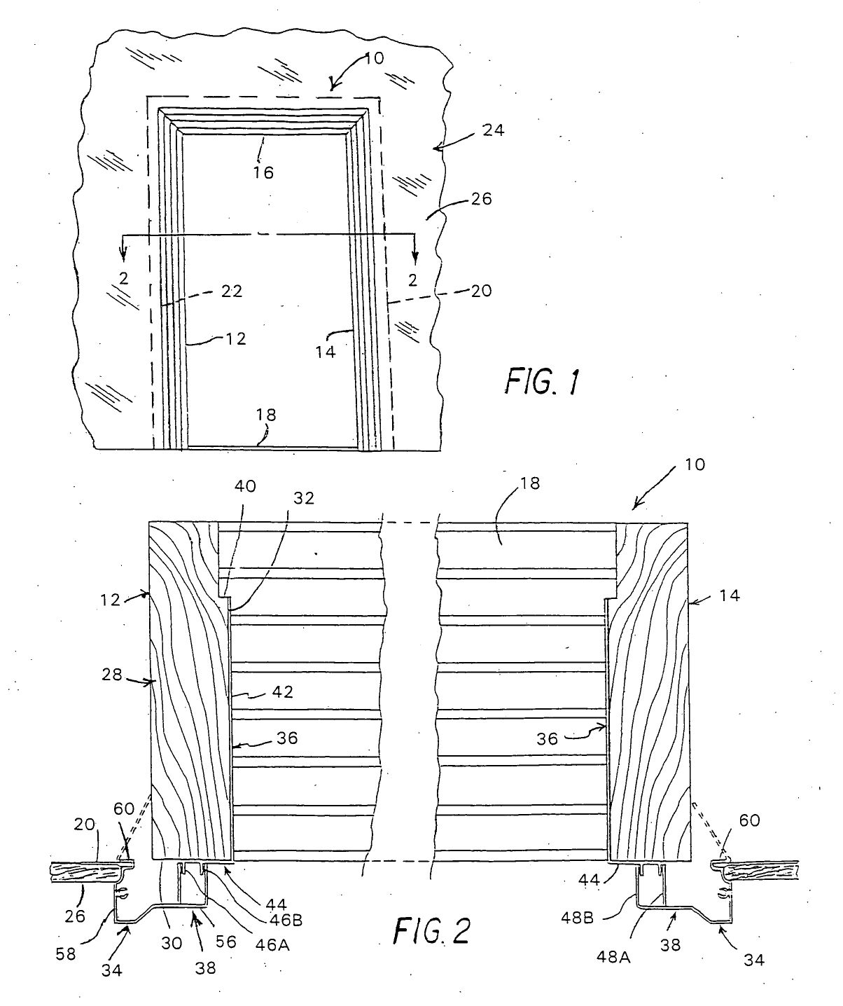

Referring now to the drawings, FIGS. 1 and 2 show a pre-assembled door frame 10 of the invention, The door frame includes a left frame element 12, a right frame element 14, a top frame element 16, and a sill 18, as well as a nailing fin 20 mounted to each of the left, right, and top frame elements. The door frame as shown in FIG. 1 has been inserted into a rough opening 22 in a building 24. As illustrated in FIGS. 1 and 2, a layer of sheet material 26 such as sheathing or siding has been installed over the nailing fin.

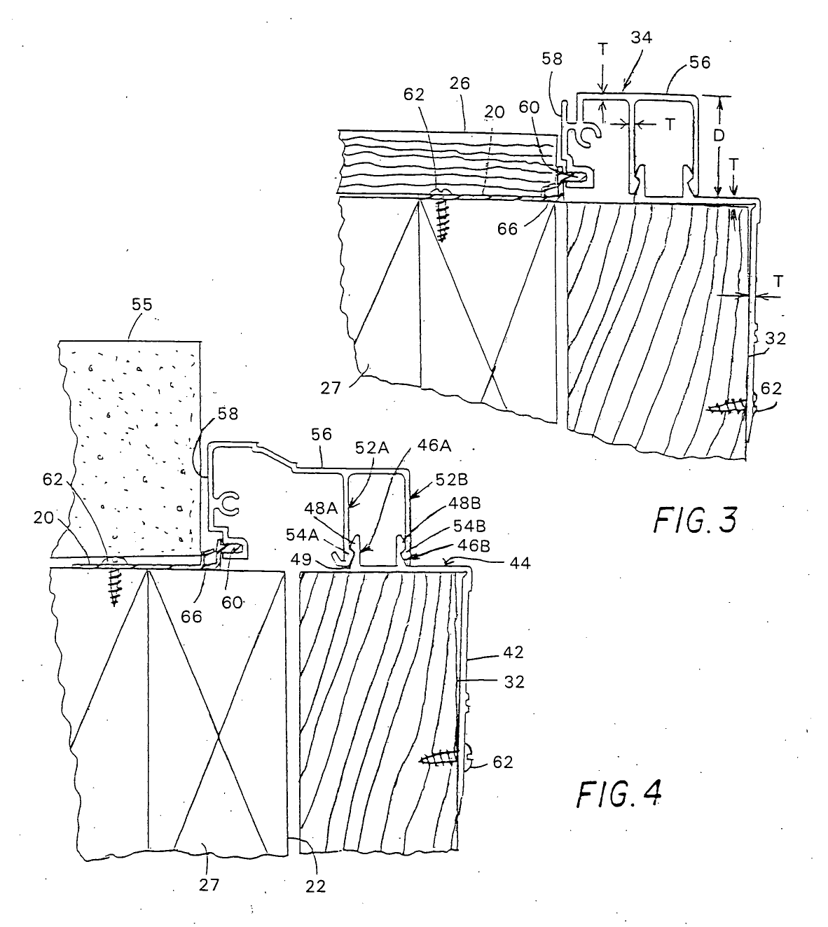

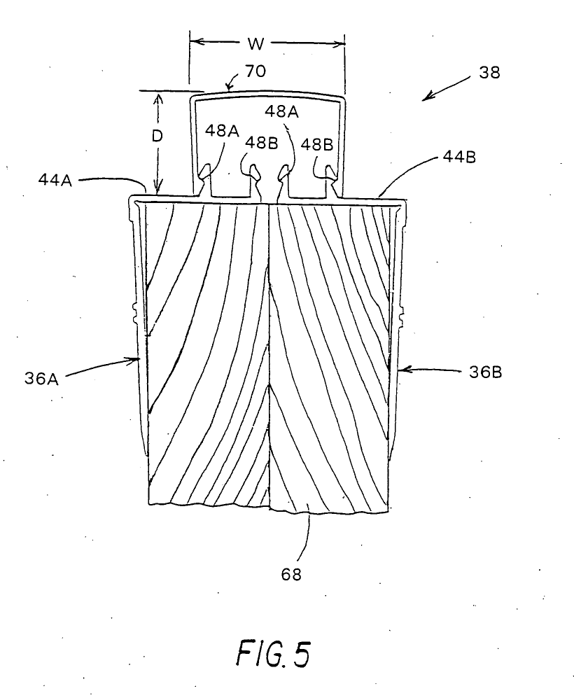

Referring to FIG. 2, the left, right, and top frame elements all have substantially the same structure, so only one will be described. Framing members 27 of the building are not shown in FIG. 2 in order to focus attention on the jamb cover assemblies of the invention. Those skilled in the art will know the typical locations of the building framing members, which are shown in FIGS. 3 and 4. Referring to the left frame element in FIG. 2, an elongate wood jamb substrate element 28 extends the full length of the left frame element and serves as a substrate for the left frame element. Substrate 28 has a length, an outer surface 30 facing outwardly away from the building and a side surface 32 facing across opening 22 in the building.

A jamb cover assembly 34 is mounted to the elongate wood substrate. The jamb cover assembly includes an elongate jamb plate 36, a nosing 38, and a respective nailing fin 20. Jamb plate 36 includes a main side panel 42 covering at least a major portion of the side surface 32 of the substrate, along at least a major portion of the length of the substrate. In preferred embodiments, as in FIGS. 1 and 2, the main side panel covers substantially the entirety of the substrate side surface from the outer surface 30 of the substrate to the door seat 40.

Jamb plate 36 further includes an outer panel 44 covering at least a substantial portion, optionally a major portion, of the outer surface 30 of the substrate, along at least a major portion of the length of the substrate. In preferred embodiments, as in FIGS. 1 and 2, the outer panel extends along substantially the entire length of the substrate outer surface. As seen in FIG. 2, the outer surface of the jamb plate is attached to main side panel 42 and extends at a perpendicular, or nearly perpendicular, angle transverse to the main side panel, and extends away from the main side panel and over the outer surface of the jamb substrate. In the embodiment illustrated, the outer panel of the jamb plate is in general surface-to-surface relationship, optionally surface-to-surface contact, with the outer surface of the substrate.

Referring more particularly to FIGS. 3 and 4, the outer panel further includes first mounting structure in the form of first and second studs 46A and 46B which have snap locks 48A and 48B on the respective studs. Outer panel 44 extends to a distal edge 49 proximate the outermost leg 46A.

Nosing 38 is shown in FIG. 2 as a cross-sectional outline commonly recognized as a “brick mold” in the building trades. Nosing 38 includes second mounting structure in the form of first and second legs 52A and 52B which have snap locks 54A, 54B on the respective legs, cooperating with snap locks 48A and 48B to mount the nosing 38 to outer panel 44 of jamb plate 36.

Legs 52A and 52B extend outwardly from studs 46A and 46B and are connected at spaced locations of the legs to a front panel 56 of the nosing. Front panel 56 extends transversely of the jamb plate main panel, and follows a direction generally corresponding to the direction of extension of outer panel 44 of the jamb plate. Front panel 56 is typically displaced from the outer surface of the substrate, and thus from the outer panel of the jamb plate, by a distance corresponding to a typical thickness of brick mold or the like. Accordingly, while spacing between the outer surface of the substrate and the front panel of the jamb plate can, in some instances, be a nominal distance, the typical application of the nosing is directed toward replacing the typical e.g. brick mold type or like trim around a door frame. Thus, typical distances between the outer surface of the substrate and the outer surface of the front panel are about 0.5 inch to about 1.5 inches, preferably about 0.6 inch to about 1.25 inches, even more preferably about 1 inch to about 1.13 inches.

As illustrated in FIGS. 2-4, front panel 56 can and typically does deviate to an extent from a true reproduction of the direction of extension of the front panel of the jamb plate, and thus can define a non-planar surface profile, or an interrupted planar surface profile, or a partially planar surface profile, of the nosing which nonetheless extends generally along, and displaced from, the outer surface of the outer panel of the jamb plate. FIG. 3 shows a profile generally corresponding with commonly known window trim profiles. FIG. 4 shows the profile generally known as a brick mold profile, and shows a brick 55 representatively shown located adjacent the brick mold.

As seen in FIGS. 2-4, front panel 56 extends away from legs 52A and 52B, away from main side panel 42 of the jamb plate, to a distal side 58 of the nosing. A nailing fin kerf 60 is built into either the jamb plate or the nosing. In general, the nailing fin kerf can be located in a region which extends from proximate the distal side of the nosing to proximate studs 46A and 46B of the outer panel of the jamb plate. In FIGS. 2-4, the nailing fin kerf is located at distal side 58 of the nosing, nailing fin 20 being mounted in kerf 60. In the embodiments illustrated in FIGS. 2-4, nailing fin kerf 60 is located at the distal side of the nosing, whereby nailing fin 20 extends outwardly from the distal side of the combination of the nosing and the jamb plate. In the embodiments shown, the nailing fin kerf is built into the distal side of the nosing. The nailing fin kerf can be located inwardly of the distal side of the nosing, more toward leg 52A. Typically, the outer panel of the jamb plate, and thus the entire jamb plate, is devoid of any nailing fin kerf. However, in some less preferred embodiments, the nailing fin kerf can be an element of the outer panel of the jamb plate, generally proximate outer stud 46A. Wherever the nailing fin kerf, the nailing fin, itself, must extend outwardly of the side edge of the nosing so that the nailing fin can be secured to framing members of the building, thereby securing the frame to the building while the nosing is assembled to the outer panel of the jamb plate.

A wide variety of mounting structures are contemplated for joining jamb plate 36 and nosing 38 to each other, whereby locks 48A, 48B, 54A, 54B are merely exemplary of such mounting structures.

While two nosing structures are illustrated in FIGS. 2-4, the nosings illustrated are merely exemplary of a wide variety of nosing structures which can be employed in the invention.

As illustrated in FIGS. 3 and 4, the jamb cover assembly 34 is secured to the jamb substrate e.g. at side surface 32 by screws, nails, or like fasteners 62. The jamb cover assembly can also be secured to the jamb substrate at other locations such as at outer surface 30 of the jamb substrate (securement not shown). The nosing is mounted to the jamb plate by the mounting structures represented by locks 48A, 48B, 54A, 54B. Nosing 38 is in turn secured to a building frame member 27 by screws, nails or like fasteners 62 through nailing fin 20.

By providing the jamb plate, the nosing, and the nailing fin as separate jamb cover elements, a wide variety of framing needs can be satisfied with a limited inventory of such cover elements.

Whereas prior art jamb cover assemblies require securing the nailing fin to the building framing member under the nosing, which requires that the nosing be assembled to the jamb plate after field installation of the frame in the rough opening at the building site; by positioning the nailing fin such that the nailing fin extends outwardly from the distal side of the jamb cover assembly in the invention, the jamb cover assembly members, including the nosing, can all be mounted, directly or indirectly, to the frame substrate elements of the door frame assembly, in an off site manufacturing facility, whereby no frame assembly need be accomplished at the building site.

Accordingly, the door frame can be shipped to the building site fully assembled. The nosing need not be shipped separately, thereby obviating any risk of losing the nosing in transit, or forgetting to put the nosing on the truck with the door frame. Similarly, the nosing need not be assembled to the frame at the building site.

Jamb plate 36 and nosing 38 are preferably metal extrusions, such as aluminum extrusions wherein the respective profile elements of the extrusions have profile thicknesses “T” of about 0.04 inch to about 0.07 inch, with preferred thicknesses of about 0.06 inch. A highly preferred thickness is about 0.062 inch.

As illustrated in FIGS. 2-4, the nailing fin includes a hinge 66 which facilitates articulating or deflecting the nailing fin downwardly toward substrate element 28 as illustrated in dashed outline in FIG. 2 for shipping the door frame, and erecting the nailing fin as illustrated in solid outline in FIG. 2 for attaching the door frame to a building.

FIG. 5 shows the principles of the jamb cover assembly, including first and second jamb plates 36 and a nosing 38, applied to a mullion substrate 68 adjacent a door opening, as a mullion cover assembly. Such mullion cover assembly can be used, for example, with the combination of a door frame and a side light, or between glass panes in a window or window cluster. As shown in FIG. 5, first and second jamb plates 36A, 36B as used in the previous embodiments as part of a door frame are positioned on opposing side surfaces of the mullion substrate. The main side surfaces of the jamb plates cover respective side surfaces of the mullion substrate.

Outer panels 44A, 44B of the respective jamb plates partially cover the outer surface of the mullion. A special mullion nosing 70 bridges the jamb plates, and snap locks to a respective snap lock structure 48A, 48B on each of the jamb plates, thereby locking together the combination of the mullion nosing and the two jamb plates.

The mullion nosing extends outwardly from the outer panels and locking studs of the jamb plates, preferably a distance “D” consistent with the distance “D” on the nosings of corresponding door jamb cover assemblies, such that the distance “D” of extension of the nosing from the jamb plates, at the mullion cover, is the same distance “D” of extension of the nosings from the jamb plates at the door frames, whereby the nosings will present a common depth appearance about the entirety of the door area.

Mullion nosing 70 is merely a further illustration of the wide variety of nosing structures which can be attached to jamb plates 36. The width “W” of the mullion nosing can be selected according to the width of the mullion substrate to which the mullion cover assembly is to be assembled, in combination with the dimensions of the jamb plates with which the mullion nosing is to be used. The width “W”, of any of the nosings 38 used with jamb cover assemblies 34, can be selected based on a variety of considerations including, without limitation, aesthetic appeal, and availability of a building framing member to receive nailing fin 20 beyond the distal side of the nosing.

The jamb and mullion cover assemblies of this invention are well suited to provide protective covering for e.g. wood, plastic, or other substrates useful in fabricating door frames, mullions, and the like. Thus, in typical application, the frame or mullion is fabricated by a frame or mullion fabricator, and shipped to a door assembler. The door assembler receives the frame as fabricated, and assembles the frames to door slabs, which are also commonly purchased separately. The door assembler adds the desired glass inset, if any, to the door slab, as needed, and assembles the door slab to a selected door frame. Typically, the basic frame is wood.

The door assembler can easily up-grade the quality and value of the door and frame by installing jamb cover assemblies of the invention to the left, right, and top frame substrate members, thus to provide a maintenance free, tough, and durable exterior surface to the frame. Mullions can be up-graded in the same manner. The thus up-graded frame and/or mullion is shipped to the builder at the building site. The builder installs the frame, with or without the door slab, in the respective rough opening in the building. If the door slab is not installed with the frame, the door slab can be installed at another time.

By designing and configuring the jamb cover assemblies of the invention with the nailing fin extending outwardly from the nosing, the on-site installation to the building can be done without removing the nosing from the jamb cover assembly. By corollary, the jamb cover assembly can be installed without the need to install the nosing to the jamb plate at the building site. Since all such assembly can be accomplished at the off-site manufacturing facility, relatively tighter tolerances can be used, assembly errors can be better controlled, and assembly damage can be better controlled or reduced, as compared to on-site assembly operations. Thus, where cover assemblies of the invention are used in constructing new buildings, the invention provides improved quality control to the process of installing door frames and mullions in the buildings.

Overall, the cover assemblies of the invention produce frames which are known as “cladded” products. Namely, typical frame materials are “cladded” with the cover assemblies of the invention in order to up-grade the value of the resulting product.

In an alternative use of jamb cover assemblies and mullion cover assemblies of the invention, the cover assemblies are installed to the jamb substrates or the mullion substrates at the building site. Such on-site installation can be used e.g. where no local door assembler provides the cladding service. In addition, such on-site installation of the cladding elements can be used to up-grade an existing building, or an existing door frame and/or mullion in an existing building. In such case, the cladding elements are installed on the jamb and/or mullion at the building site as add-on components of the respective frame or mullion.

It should be noted that, while the above embodiments, such as at FIG. 1, have suggested use of the invention with personnel doors, the invention can be used with doors of practically any size. Thus, the inventor contemplates use of the invention on, for example and without limitation, garage doors, doors at truck shipping docks, double personnel doors, Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. An elongate jamb plate adapted to be mounted to a jamb substrate of a door frame, said jamb plate comprising:
(a) a main side panel adapted to cover at least a major portion of a side surface of such jamb substrate, along at least a major portion of a length of such jamb substrate; and
(b) an outer panel adapted to extend along at least a major portion of a length of such jamb substrate, and extending at an angle transverse to said main side panel, and extending away from said main side panel, thereby to extend over an outer surface of such jamb substrate, said outer panel bearing mounting structure, said mounting structure comprising locking structure adapted to receive an elongate nosing and to lock such elongate nosing to said jamb plate,
whereby said jamb plate and such elongate nosing can be collectively mounted to such jamb substrate.

2. An elongate jamb plate as in claim 1, said mounting structure comprising first and second spaced legs, extending outwardly from said outer panel, said locking structure being disposed on at least one of said legs.

3. An elongate jamb plate as in claim 2, the extension of said outer panel, away from said main side panel, ending at an outermost one of said legs.

4. An elongate jamb plate as in claim 1 wherein said jamb plate comprises an aluminum extrusion having nominal profile thicknesses of about 0.06 inch.

5. An elongate nosing adapted to be mounted to an elongate jamb plate, wherein such elongate jamb plate is adapted and configured to be mounted on an elongate jamb substrate of a door frame, wherein such elongate jamb plate comprises a main side panel adapted to cover at least a major portion of a side surface of such jamb substrate, along at least a major portion of a length of such jamb substrate, and wherein such elongate jamb plate further comprises an outer panel for extending along a least a major portion of the length of such jamb substrate, such outer panel being configured to extend at an angle transverse to such main side panel, and away from such main side panel and over an the outer surface of such jamb substrate, such outer panel bearing a first mounting structure, said elongate nosing comprising
a front panel (56), and first (52A) and second (52B) spaced legs which extend, along approximately equal lengths thereof, transversely away from such front panel, and second mounting structure on said legs (52A, 52B), said second mounting structure being located at a terminus of at least one of said legs, and being adapted and configured to cooperatively mount said nosing to such jamb plate,
whereby said nosing and said jamb plate can be collectively mounted to such jamb substrate.

6. (canceled).

7. An elongate nosing as in claim 5, and including a mounting fin in said mounting fin kerf.

8. An elongate nosing as in claim 5, said mounting fin comprising a polymeric mounting fin.

9. An elongate nosing as in claim 8 wherein said polymeric mounting fin is deflectable toward such main side panel of such jamb plate, and into proximity with a such jamb substrate when said elongate nosing is mounted to a such jamb plate which is mounted to a such jamb substrate.

10. An elongate nosing as in claim 5 wherein said elongate nosing comprises an aluminum extrusion having nominal profile thicknesses of about 0.06 inch.

11. In combination, an elongate jamb plate, and an elongate nosing,
said elongate nosing being adapted and configured to be mounted to said elongate jamb plate,
said elongate jamb plate being adapted and configured to be mounted to a jamb substrate, which jamb substrate is adapted and configured to be mounted in a rough opening in a building,
said jamb plate comprising
(a) a main side panel adapted to cover at least a portion of a side surface of such jamb substrate, and
(b) an outer panel extending at an angle transverse to said main side panel, thereby to extend over the outer surface of such jamb substrate, said outer panel comprising a first mounting structure,
said elongate nosing comprising
(c) a second mounting structure, adapted and configured to cooperatively engage said first mounting structure of said jamb plate, thereby to mount said nosing and said jamb plate to each other, said nosing, when so mounted to said jamb plate, extending
(i) in a direction away from said main side panel of said jamb plate and alone the outer surface of such jamb substrate, to a distal side of said nosing, and
(ii) in a direction away from such building.

12. A combination as in claim 11, said mounting fin kerf being disposed on said nosing.

13. A combination as in claim 11, said mounting fin kerf being disposed on said outer panel of said jamb plate.

14. A combination as in claim 11, and including a mounting fin in said mounting fin kerf and extending outwardly beyond the distal side of said nosing and away from said main side panel of said jamb plate.

15. A combination as in claim 11, said first mounting structure comprising first and second studs extending from said outer panel of said jamb plate.

16. A combination as in claim 11, said nosing comprising first and second spaced legs, connected at spaced locations of said legs to a front panel of said nosing, said second mounting structure being disposed on said legs.

17. A combination as in claim 11 wherein said second mounting structure on said nosing is removably snap lockable to said first mounting structure on said outer panel of said jamb plate.

18. A combination as in claim 15 wherein said second mounting structure on said nosing can snap lock to said studs.

19. A combination as in claim 11, and including a mounting fin in said mounting fin kerf, said mounting fin comprising a polymeric fin mounted in said combination of said jamb plate and said nosing at said mounting fin kerf.

20. A combination as in claim 12, and including a mounting fin in said mounting fin kerf, said mounting fin comprising a polymeric fin mounted in said combination of said jamb plate and said nosing at said mounting fin kerf.

21. A combination as in claim 13, and including a mounting fin in said mounting fin kerf, said mounting fin comprising a polymeric fin mounted in said combination of said jamb plate and said nosing at said mounting fin kerf.

22. A combination as in claim 19 wherein said mounting fin is deflectable toward said main side panel of said jamb plate, and into proximitywith such jamb substrate when said elongate nosing is mounted to said jamb plate and said jamb plate is mounted to a such jamb substrate.

23. A combination as in claim 20 wherein said mounting fin is deflectable toward said main side panel of said jamb plate, and into proximity with such jamb substrate when said elongate nosing is mounted to said jamb plate and said jamb plate is mounted to a such jamb substrate.

24. A combination as in claim 21 wherein said mounting fin is deflectable toward said main side panel of said jamb plate, and into proximity with such jamb substrate when said elongate nosing is mounted to said jamb plate and said jamb plate is mounted to a such jamb substrate.

25. A combination as in claim 11 wherein said jamb plate comprises an aluminum extrusion having nominal profile thicknesses of about 0.06 inch.

26. A combination as in claim 11 wherein said nosing comprises an aluminum extrusion having nominal profile thicknesses of about 0.06 inch.

27. A pre-assembled door frame adapted to be assembled feF assembly into a building at an opening in such building, said pre-assembled door frame comprising:
(a) an elongate jamb substrate adapted to be positioned generally in facing relationship with a framing element of such building, said jamb substrate having a length, an outer surface of said jamb substrate being adapted to face outwardly away from such building when said door frame is assembled to such building, and a side surface of said jamb substrate being adapted to face across such opening whereat said door frame is assembled to such building; and
(b) a jamb cover assembly on said elongate jamb substrate, said jamb cover assembly comprising
(i) a jamb plate comprising
a main side panel covering at least a portion of the side surface of said substrate, and
an outer panel extending at an angle transverse to said main side panel, and extending away from said main side panel and over the outer surface of said jamb substrate, said outer panel comprising a first mounting structure extending outwardly of said outer panel in a direction away from such building from the outer surface of said jamb substrate, and
(ii) an elongate nosing comprising a second mounting structure, engaged with said first mounting structure on said outer panel of said jamb plate and thereby mounting said nosing and said jamb plate to each other, said nosing extending in a direction away from said main side panel of said jamb plate and terminating at to a distal side of said nosing,
said jamb cover assembly comprising a mounting fin extending, from one of said nosing and said outer panel outwardly beyond the distal side of said nosing and in a direction away from said main side panel of said jamb plate, said mounting fin being adapted and configured to receive fasteners therethrough, thereby to mount said jamb cover assembly to such building, said first mounting structure comprising first and second studs extending from said outer panel of said jamb plate to ends thereof, and having locking loci proximate the ends of said first and second studs.

28. A pre-assembled door frame as in claim 27, and including a mounting fin kerf on one of said nosing and said jamb plate, said mounting fin being received in said mounting fin kerf.

29. A pre-assembled door frame as in claim 27, and including a mounting fin kerf on said nosing, said mounting fin being received in said mounting fin kerf.

30. A pre-assembled door frame as in claim 27, and including a mounting fin kerf proximate the distal side of said nosing, said mounting fin being received in said mounting fin kerf.

31. A pre-assembled door frame as in claim 27, said first mounting structure comprising first and second studs extending from said outer panel of said jamb plate.

32. A pre-assembled door frame as in claim 27, said nosing comprising first and second spaced legs, connected at spaced locations of said legs to a front panel of said nosing, said second mounting structure being disposed on said legs.

33. A pre-assembled door frame as in claim 27 wherein said second mounting structure on said nosing snap locks to said first mounting structure on said outer panel of said jamb plate.

34. A pre-assembled door frame as in claim 27 wherein said second mounting structure on said nosing snap locks to said studs.

35. A pre-assembled door frame as in claim 27, said outer panel of said jamb plate being in surface-to-surface relationship with the outer surface of said jamb substrate.

36. A pre-assembled door frame as in claim 28, said mounting fin comprising a polymeric fin mounted in said jamb cover assembly at said mounting fin kerf.

37. A pre-assembled door frame as in claim 29, said mounting fin comprising a polymeric fin mounted in said jamb cover assembly at said mounting fin kerf.

38. A pre-assembled door frame as in claim 30, said mounting fin comprising a polymeric fin mounted in said jamb cover assembly at said mounting fin kerf.

39. A pre-assembled door frame as in claim 36 wherein said mounting fin is deflectable so as to be folded against said jamb substrate.

40. A pre-assembled door frame as in claim 37 wherein said mounting fin is deflectable so as to be folded against said jamb substrate.

41. A pre-assembled door frame as in claim 38 wherein said mounting fin is deflectable so as to be folded against said jamb substrate.

42. A pre-assembled door frame as in claim 27 wherein said jamb plate comprises an aluminum extrusion having nominal profile thicknesses of about 0.06 inch.

43. A pre-assembled door frame as in claim 27 wherein said nosing comprises an aluminum extrusion having nominal profile thicknesses of about 0.06 inch.

44-52. (canceled)

53. An elongate jamb plate as in claim 1 wherein, when said jamb plate is assembled to such jamb substrate, such side surface of such jamb plate remains uncovered over a portion of such width dimension of such jamb substrate, the uncovered portion being disposed inwardly in such building from said outer panel.

54. An elongate jamb plate as in claim 1, said outer panel being devoid of structure adapted to mount said jamb plate to such building.

55. An elongate nosing as in claim 5, said nosing further comprising a mounting fin kerf located proximate the distal side of said nosing and away from such main side panel of such jamb plate.

56. An elongate jamb plate adapted to be mounted to a jamb substrate of a door frame, which door frame is adapted to be mounted in a rough opening in a building, wherein such jamb substrate has an inner surface disposed toward such rough opening, said jamb plate comprising:
(a) a main side panel adapted to cover substantially less than all of a side surface of such jamb substrate, said main side panel having a front edge and a rear edge, the front and rear edges being coplanar with a flat such inner surface of such jamb substrate; and
(b) an outer panel adapted to extend along at least a major portion of the length of such jamb substrate, and extending at an angle transverse to said main side panel, and extending away from said main side panel, thereby to extend over an outer surface of such jamb substrate and correspondingly away from such rough opening of such building, said outer panel bearing mounting structure adapted to mount said outer panel to an elongate nosing, and being devoid of structure adapted to mount said jamb plate to such building.

57. An elongate jamb plate adapted to be mounted to a jamb substrate of a door frame, which door frame is adapted to be mounted in a rough opening in a building, said jamb plate comprising:
(a) a main side panel adapted to cover substantially less than all of a side surface of such jamb substrate; and
(b) an outer panel adapted to extend along at least a major portion of the length of such jamb substrate, said outer panel beginning at a joinder between said outer panel and said main side panel and extending, at an angle transverse to said main side panel, away from said main side panel, thereby to extend over an outer surface of such jamb substrate and correspondingly away from such rough opening of such building, said outer panel bearing locking mounting structure adapted to mount said outer panel to an elongate nosing.

58. In combination, an elongate jamb plate, and an elongate nosing,
said elongate nosing being adapted and configured to be mounted to said elongate jamb plate,
said elongate jamb plate being adapted and configured to be mounted to a jamb substrate, thus to form a covered jamb assembly, which covered jamb assembly is adapted and configured to be mounted in a rough opening in a building,
said jamb plate comprising
(a) a main side panel adapted to cover substantially less than all of a side surface of such jamb substrate, and
(b) an outer panel extending at an angle transverse to said main side panel, and extending away from said main side panel, thereby to extend over the outer surface of such jamb substrate, said outer panel comprising first mounting structure,
said elongate nosing comprising
(c) second mounting structure, adapted and configured to cooperatively engage said first mounting structure of said jamb plate, thereby to mount said nosing and said jamb plate to each other, said nosing, when so mounted to said jamb plate, extending
(i) in a direction away from said main side panel of said jamb plate and along the outer surface of such jamb substrate, to a distal side of said nosing, and
(ii) in a direction away from such building,
the combination of said jamb plate and said nosing comprising a mounting fin kerf in a region which extends from proximate the distal side of said nosing to proximate said first mounting structure, and further comprising a mounting fin in said mounting fin kerf, said mounting fin extending away from said main side panel of said jamb plate.

59. A combination as in claim 58, said mounting fin kerf being disposed on said nosing.

60. A combination as in claim 58, said first mounting structure comprising first and second studs extending from said outer panel of said jamb plate to ends thereof, and having locking loci proximate the ends of said first and second studs.

61. A combination as in claim 58, said mounting fin comprising a flexible polymeric mounting fin extending outwardly beyond the distal side of said nosing.

62. A combination as in claim 58, said mounting fin comprising a deflectable polymeric mounting fin extending, from said mounting fin kerf, away from said main side panel of said jamb plate, said mounting fin being deflectable toward said main side panel of said jamb plate, and into proximity with said jamb plate, or such jamb substrate when said jamb plate is mounted to such jamb substrate.

63. A jamb cover assembly adapted and configured to be mounted to a jamb substrate, and such jamb substrate mounted in a building, said jamb cover assembly comprising:
(a) a jamb plate, comprising
(i) a main side panel, and
(ii) an outer panel extending at an angle transverse to said main side panel, and extending away from said main side panel, said outer panel comprising a first mounting structure extending outwardly of such building from an outer surface of said outer panel when a combination of said jamb plate and such jamb substrate is assembled into such building; and
(b) an elongate nosing comprising a second mounting structure, engaged with said first mounting structure on said outer panel of said jamb plate and thereby mounting said nosing and said jamb plate to each other,
at least one of said first and second mounting structures comprising at least a first leg extending toward the other of said first and second mounting structures, a locking locus on said first leg being disposed proximate an end of the respective said leg.

64. A jamb cover assembly as in claim 63, the respective said at least one of said first and second mounting structures comprising first and second legs extending toward the other of said first and second mounting structures, cross-sections of said first and second legs being substantial mirror images of each other.

65. A jamb assembly, comprising:
(a) an elongate substrate adapted to be positioned generally in facing relationship with a framing element of a building, said jamb substrate having a length, an outer surface of said jamb substrate being adapted to face outwardly away from such building when said jamb assembly is assembled to such building, a first side surface of said jamb substrate being adapted to face across such opening whereat said door frame is assembled to such building, and a second side surface opposite said first side surface; and
(b) a two-component jamb cover assembly on said elongate jamb substrate, said jamb cover assembly extending a substantial distance beyond said second side surface of said jamb substrate, and comprising
(i) a jamb plate comprising
a main side panel covering at least a portion of the side surface of said substrate, and
an outer panel extending at an angle transverse to said main side panel, and extending away from said main side panel and over the outer surface of said jamb substrate, said outer panel comprising first mounting structure extending outwardly away from said outer panel in a direction away from the outer surface of said jamb substrate, and
(ii) an elongate nosing comprising second mounting structure, engaged with said first mounting structure on said outer panel of said jamb plate and thereby mounting said jamb plate and said nosing to each other,
at least one of said first and second mounting structures comprising first and second legs extending, toward the other of said first and second mounting structures, to ends of the respective said legs.

66. A jamb assembly as in claim 65, at least one of said first and second legs having a locking locus proximate the end of the respective said leg.

67. A jamb assembly as in claim 65, further comprising a flexible polymeric mounting fin mounted in said two-component jamb cover assembly.

68. A jamb cover assembly as in claim 58, at least one of said jamb plate and said nosing comprising an aluminum extrusion having nominal profile thickness of about 0.06 inch.

69. A jamb assembly as in claim 65, at least one of said jamb plate and said nosing comprising an aluminum extrusion having nominal profile thickness of about 0.06 inch.

70. A jamb cover assembly as in claim 63, said jamb cover assembly comprising a two-component jamb cover assembly defined by said jamb plate and said elongate nosing.

71. A jamb cover assembly as in claim 63, further comprising a mounting fin mounted in said jamb cover assembly.

72. A jamb assembly as in claim 65, cross-sections of said first and second legs comprising substantial mirror images of each other.
